(19) United States
(12) Patent Application Publication
(10) Pub. No.: US 2008/0086260 A1
(43) Pub. Date: Apr. 10, 2008

(54) APPARATUS AND METHOD FOR RECOGNIZING VOICE IN VEHICLES

(75) Inventors: Kook-Yeon LEE, Suwon-si (KR); Jin-Won Kim, Seoul (KR); Byoung-Ki Jeon, Gunpo-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/833,554

(22) Filed: Aug. 3, 2007

(30) Foreign Application Priority Data
Aug. 3, 2006 (KR) 73330/2006

(51) Int. Cl. G01C 21/00; G06F 3/01

(52) U.S. Cl. 701/200

(57) ABSTRACT

An in-vehicle voice recognition apparatus and method for outputting a voice for notifying when a factor interfering with voice recognition is detected on a road on which a vehicle travels. A camera unit takes an image of the road on which the vehicle travels and transmits the taken road image to a navigation system. An acceleration sensor measures acceleration variation values of the vehicle during traveling and transmits the measured acceleration variation values of the vehicle to the navigation system. The navigation system controls an operation for outputting a voice when a factor interfering with the voice recognition is determined to be present on the road on which the vehicle travels through at least one of the road image received from the camera unit, the acceleration variation values of the vehicle received from the acceleration sensor, and map data.

### PRIORITY

This application claims priority under 35 U.S.C. § 119 to an application filed in the Korean Intellectual Property Office on Aug. 3, 2006 and assigned Serial No. 2006-73330, the contents of which are incorporated herein by reference.

### BACKGROUND OF THE INVENTION

1. Field of the Invention

The present invention generally relates to an apparatus and method for recognizing voice in vehicles, and more particularly to an in-vehicle voice recognition apparatus and method for outputting a voice for notifying when a factor interfering with voice recognition is detected while a vehicle is moving.

2. Description of the Related Art

Voice recognition is a set of processes in which phonemes, i.e., linguistic information, are extracted from acoustic information of voice and a machine reacts by recognizing the linguistic information. Among information exchange methods between humans and machines, a voice conversation is regarded as the most natural and simple method. However, there is a limitation in that the voice of a person should be converted into a code capable of being processed in a machine for a conversation therewith. This code conversion process is a voice recognition process.

In terms of voice recognition technology, research is being conducted on continuous voice recognition of large vocabularies beyond a small-vocabulary isolated-word level. Technology for realizing a natural conversation between a person and a machine will be time-consuming. In implementing advanced voice recognition technology, there are problems relating to pronunciation habits, a sex distinction, a co-articulation phenomenon, computational capability of a computer, background noise, and a distortion phenomenon due to channel noise on a line for transmitting a voice signal. Since the development of computers in the middle of the 20^{th} century, voice recognition technology has been continuously developed in relation to the above-described problems. A system using human voice information can be required for all home appliances, computers, security systems, next generation transportation means including automobiles, trains and airplanes, and various machines. Actually, voice recognition systems are being developed in almost all fields.

In terms of in-vehicle voice recognition technology, a navigation system with a voice recognition function can be installed in a vehicle. In this case, a driver inputs a voice command through a microphone attached to a handle bar or a weather guard. Several methods are used to process a voice command signal input through the microphone.

A method sends a voice command signal to a voice processing center of a mobile communication provider using a Code Division Multiple Access (CDMA) mobile communication system and receives a voice recognition result. This method is advantageous in that a software size of the in-vehicle navigation system is small because a voice recognition engine and database (DB) are provided in the voice processing center. However, this method is disadvantageous in that fees to use mobile communication and packet transmission fees mapped to a voice recognition result value are required because the mobile communication is used.

In another method, a voice recognition engine and DB are mounted in an in-vehicle navigation system. Thus, because the system independently processes voice recognition, a connection to the voice processing center through mobile communication is unnecessary and therefore a voice recognition processing time is shortened. This method is advantageous in that the fees to use mobile communication and the packet transmission fees are not required.

In the method in which a voice recognition engine and DB are mounted in the in-vehicle navigation system, voice recognition is very sensitive to noise. Voice recognition is affected by road condition while a vehicle travels even though background noise such as fan and engine noise of the vehicle is eliminated.

That is, the driver may be shaken when the vehicle travels on an uneven or broken road or his/her head may be turned in a rotation direction of a steering wheel or handle bar when the vehicle travels on a curve road. In this situation, speech of the driver may be unclear or a transfer direction of the speech may be changed when the driver inputs a voice command. Thus, voice recognition may not be processed due to the unclear voice command of the driver.

### SUMMARY OF THE INVENTION

It is, therefore, an aspect of the present invention to provide an in-vehicle voice recognition apparatus and method for outputting a voice for notifying when a factor interfering with voice recognition is detected while a vehicle travels on a road.

In accordance with an aspect of the present invention, there is provided an in-vehicle voice recognition apparatus operating according to road condition, the apparatus including a camera unit for taking an image of a road on which a vehicle travels and transmitting the taken road image to a navigation system; an acceleration sensor for measuring acceleration variation values of the vehicle during traveling and transmitting the measured acceleration variation values of the vehicle to the navigation system; and the navigation system for controlling an operation for outputting a voice for notifying when a factor interfering with voice recognition is determined to be present on the road on which the vehicle travels through at least one of the road image received from the camera unit, the acceleration variation values of the vehicle received from the acceleration sensor, and map data.

In accordance with another aspect of the present invention, there is provided an in-vehicle voice recognition method operating according to a road condition, the method including checking road conditions during traveling in a navigation operation mode when a voice recognition mode operates in a vehicle; and outputting a voice for notifying when a factor interfering with voice recognition is determined to be present on a road on which the vehicle travels.

In accordance with yet another aspect of the present invention, there is provided an in-vehicle voice recognition method operating according to a road condition, the method including checking road conditions during traveling when a user inputs a voice command in a navigation operation mode of a vehicle in which a voice recognition mode operates; and requesting a voice command re-input through voice when a factor interfering with voice recognition is determined to be present on a road on which the vehicle travels according to a result obtained by checking the road conditions.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an in-vehicle voice recognition apparatus in accordance with the present invention;

FIG. 2 is a flowchart illustrating a voice output process for giving notification of a road condition while a vehicle travels in the in-vehicle voice recognition apparatus in accordance with the present invention;

FIG. 3 is a flowchart illustrating a process for determining whether an object interfering with voice recognition is present on a road on which the vehicle travels in the process of FIG. 2; and

FIGS. 4A and 4B illustrate images displayed by the in-vehicle voice recognition apparatus of FIG. 1.

### DETAILED DESCRIPTION OF THE PREFERRED EMBODIMENTS

Preferred embodiments of the present invention will be described in detail herein below with reference to the accompanying drawings. In the drawings, the same or similar elements are denoted by the same reference numerals even though they are depicted in different drawings.

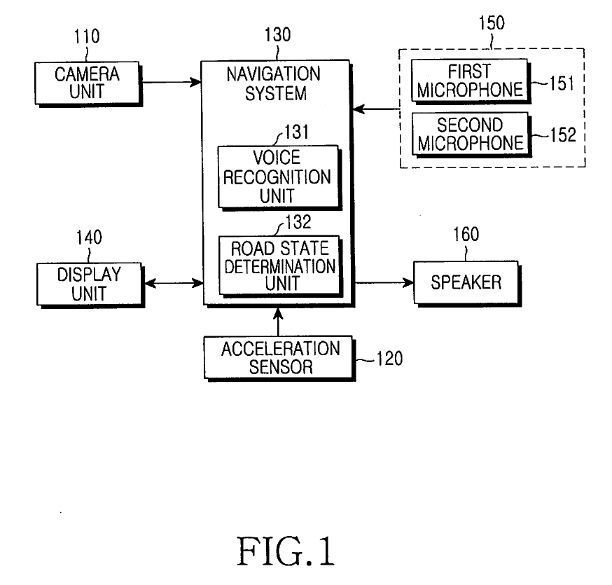

FIG. 1 shows an in-vehicle voice recognition apparatus in accordance with the present invention.

A camera unit 110 includes a camera sensor for capturing image data and converting a captured optical signal into an electrical signal and an image processor for converting an analog image signal from the camera sensor into digital data, processing the digital data in a frame unit, and outputting the frame image data in a regular size.

The camera unit 110 is installed facing a forward direction of a vehicle to take an image of a road condition while the vehicle travels on a road. The camera unit 110 captures image data of the road on which the vehicle travels, and transmits the captured road image data to a navigation system 130.

An acceleration sensor 120 may be installed as an additional module in the vehicle or may be included and installed in the navigation system 130. Further, the acceleration sensor 120 can be an acceleration sensor of two X and Y axes and can sense the traveling speed of the vehicle. The X axis of the acceleration sensor is in a traveling direction of the vehicle and the Y axis thereof is in a direction perpendicular to the X axis.

The acceleration sensor 120 extracts a first acceleration variation value X_{acc} and a second acceleration variation value Y_{acc} corresponding to acceleration variation values of the vehicle in operation during an arbitrary time, and transmits the extracted first and second acceleration variation values X_{acc} and Y_{acc} to the navigation system 130.

The navigation system 130 detects a traveling direction and distance of the vehicle using direction and distance sensors and receives a signal from a Global Positioning System (GPS) using an absolute position sensor. The navigation system 130 computes its position (or traveling position) by combining signals from the direction sensor, the distance sensor, and the absolute position sensor with road map data (or a road map) stored in a memory (not illustrated) of the navigation system, and displays the computed position on a display unit 140.

The navigation system 130 includes a voice recognition unit 131. The voice recognition unit 131 includes a voice recognition engine and database (DB) for processing a voice command input through a microphone 150.

The navigation system 130 outputs a voice for notifying when a factor interfering with the voice recognition is present on the road on which the vehicle travels. If a factor interfering with the voice recognition is present on the road on which the vehicle travels, the navigation system 130 outputs a voice for requesting a voice command re-input.

The navigation system 130 includes a road condition determination unit 132 for determining whether a factor interfering with the voice recognition is present on the road on which the vehicle travels.

The road condition determination unit 132 compares a road image received from the camera unit 110 with a basic pattern image stored in the memory (not shown) of the navigation system 130. If the road image is different from the basic pattern image as a comparison result, the road condition determination unit 132 determines that an interfering object, such as an obstacle, a broken road, an uneven road, etc., is present on the road, and then transmits a determination result to a controller (not illustrated) of the navigation system 130. The basic pattern image is a basic road image in which traffic lanes are drawn on both sides thereof. If the road image received from the camera unit 110 includes an image other than the basic pattern image, the image is determined to be an image of an interfering object.

The memory can store images for identifying types of interfering objects as well as the basic pattern image. Thus, the road condition determination unit 132 determines that the basic pattern image is different from the road image including the image of the interfering object, and compares the road image with the images for identifying the types of interfering objects. Then, the road condition determination unit 132 can detect which type of interfering object is present on the road among the types of interfering objects, such as an obstacle, an uneven road, a broken road, and so on.

Further, the road condition determination unit 132 compares the acceleration variation values X_{acc} and Y_{acc} of the vehicle received from the acceleration sensor 120 with shock threshold values Xₜₕ and Yₜₕ stored in the memory. If the first acceleration variation value X_{acc} of the acceleration variation values X_{acc} and Y_{acc} is greater than the first shock threshold value Xₜₕ of the shock threshold values Xₜₕ and Yₜₕ and the second acceleration variation value Y_{acc} is greater than the second shock threshold value Yₜₕ, the road condition determination unit 132 determines that an interfering object, such as the obstacle, the uneven road, the broken road, etc., is present on the road on which the vehicle travels. Then, the road condition determination unit 132 transmits a determination result to the controller (not illustrated) of the navigation system. The shock threshold values Xₜₕ and Yₜₕ are reference values for determining whether a factor interfering with the voice recognition is present on the road according to the acceleration variation values of the vehicle. The shock threshold values can be set and stored in advance.

Further, the road condition determination unit 132 first compares the road image received from the camera unit 110 with the basic pattern image and then determines whether a factor interfering with the voice recognition is present on the road. If an interfering object is determined to be present on the road through the road image, the road condition determination unit 132 determines whether an object interfering with the voice recognition is present on the road by comparing the acceleration variation values X_{acc} and Y_{acc} of the vehicle received from the acceleration sensor 120 with the shock threshold values Xₜₕ and Yₜₕ. If an interfering object is determined to be present on the road through the acceleration variation values X_{acc} and Y_{acc}, the road condition determination unit 132 determines which type of interfering object is present on the road among the types of interfering objects, such as the obstacle, the uneven road, the broken road, and so on, and then transmits a determination result to the controller (not illustrated) of the navigation system 130.

Further, the road condition determination unit 132 searches for a current traveling position of the vehicle in operation using the road map data stored in the memory. When determining that the vehicle travels on a curve road, the road condition determination unit 132 determines that the curve road is a factor interfering with the voice recognition and then transmits a determination result to the controller (not illustrated) of the navigation system 130.

If the controller (not illustrated) of the navigation system 130 receives information indicating that an interfering object is present on the road on which the vehicle travels or information indicating that the vehicle travels on a curve road, the controller controls an operation for outputting a voice for giving notification of the received information. Alternatively, when the controller of the navigation system 130 receives the information indicating that the interfering object is present on the road or the information indicating that the vehicle travels on the curve road in a state in which a user has input a voice command, the controller controls an operation for outputting a voice for requesting a voice command re-input.

The display unit 140 displays map data in navigation operation mode of the vehicle in which voice recognition mode operates and displays a processing state and result of the voice recognition. The display unit 140 can be installed on a dashboard of the vehicle.

The microphone 150 receives a voice command of the user and can be installed on the handle bar and/or the weather guard of the vehicle. The microphone 150 is configured with first and second microphones 151 and 152. When interference voice or non-static sound is separated using the two microphones 151 and 152, interference sound can be effectively removed.

A speaker 160 can output a voice guidance message and a voice for giving notification of a road condition in the navigation operation mode of the vehicle in which the voice recognition mode operates. The speaker 160 can be additionally installed in the vehicle or can be a speaker already mounted in the vehicle.

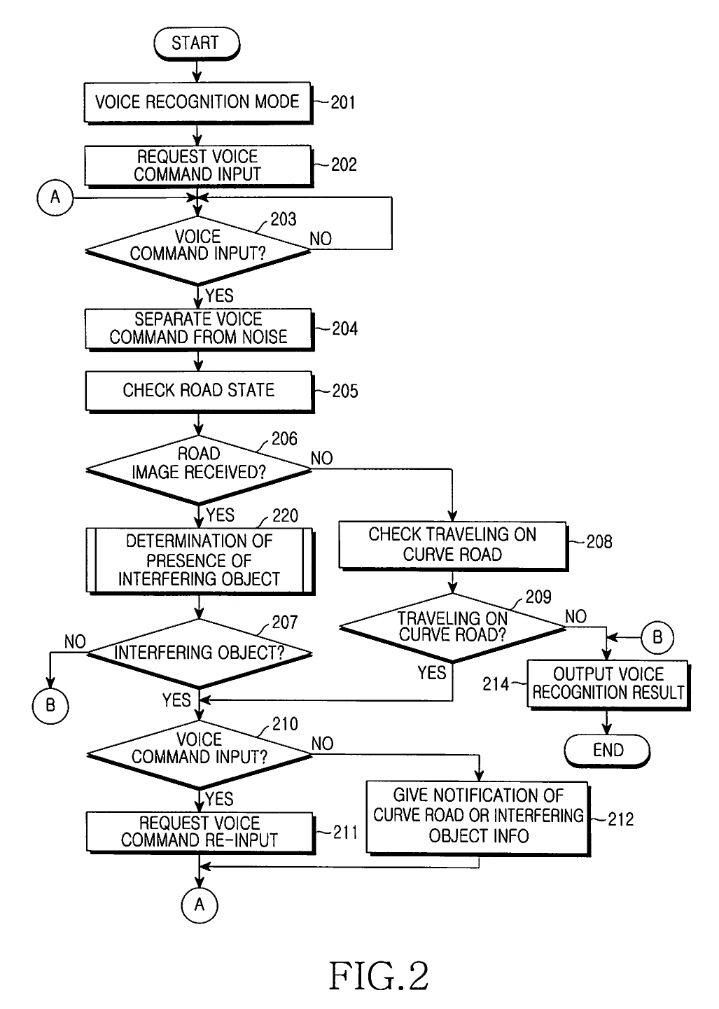

A voice output operation for giving notification of a road condition while the vehicle travels in the in-vehicle voice recognition apparatus will be described in detail with reference to FIGS. 2 to 4.

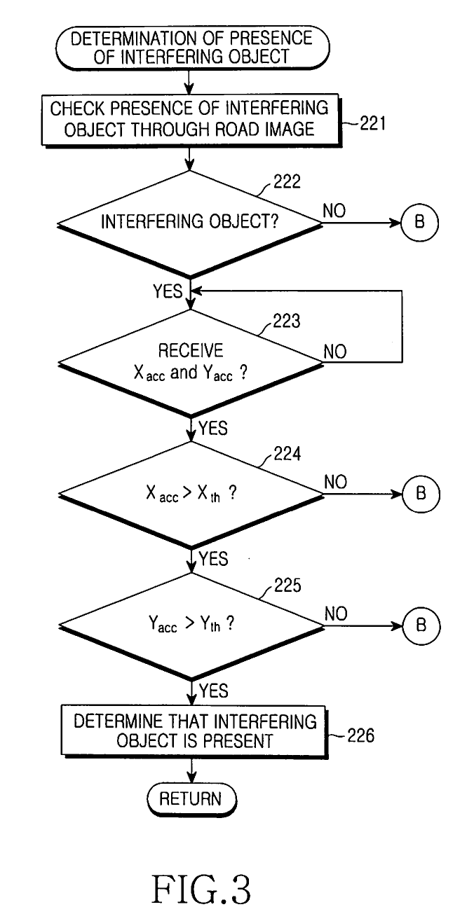

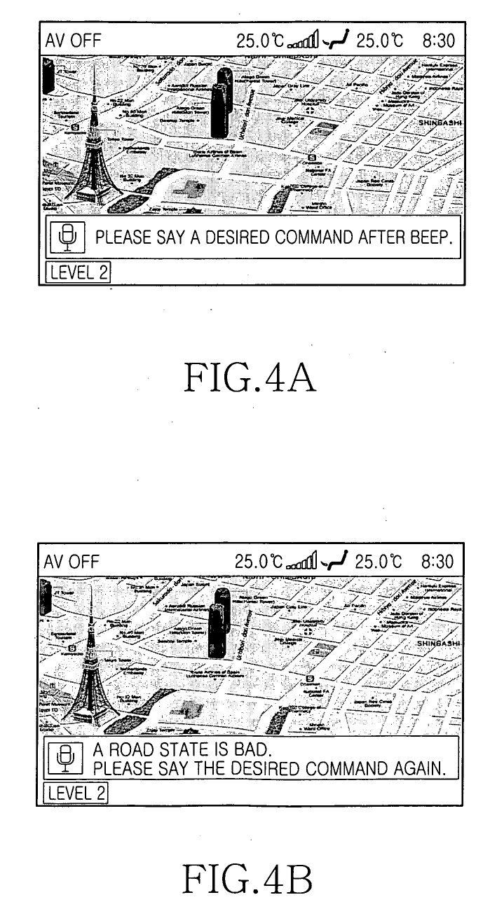

FIG. 2 shows a voice output process for giving notification of a road condition while a vehicle travels in the in-vehicle voice recognition apparatus in accordance with the present invention, and FIG. 3 shows a process for determining whether an object interfering with voice recognition is present on a road on which a vehicle travels in the process of FIG. 2. FIGS. 4A and 4B show images displayed by the in-vehicle voice recognition apparatus of FIG. 1.

Referring to FIG. 2, in a navigation operation mode of the vehicle in which a voice recognition mode operates in step 201, the controller of the navigation system (hereinafter, referred to as the controller) outputs a voice for requesting a voice command input of the user through the speaker 160 as shown in FIG. 4A in step 202. The navigation operation mode of the vehicle in which the voice recognition mode operates is the mode for recognizing a voice command input by the user and processing an associated navigation operation.

When the user inputs a voice command through the microphone 150, the controller senses the input voice command in step 203 and then proceeds to step 204 to remove noise from the voice command input through the microphone 150 and separate only the voice command. In step 204, when the two microphones 151 and 152 are used, a beam pattern is formed in a sound source direction and therefore static/non-static noise is removed, so the desired voice can be separated.

When the user inputs a voice command, the controller controls an operation for checking a road condition while the vehicle travels through the road condition determination unit 132 in step 205. In step 205, the road condition determination unit 132 determines whether an interfering object or a curve road is present as a factor interfering with the voice recognition while the vehicle travels on the road.

When receiving an image of the road on which the vehicle travels from the camera unit 110, the road condition determination unit 132 detects the received road image in step 206 and determines whether the interfering object is present on the road in step 220.

The process for determining whether the interfering object is present on the road in step 220 will be described in detail with reference to FIG. 3.

Referring to FIG. 3, the camera unit 110 takes an image of a road on which the vehicle travels under control of the controller in the navigation operation mode of the vehicle in which the voice recognition mode operates in step 201. The camera unit 110 transmits the taken road image to the navigation system 130 in a regular period.

When receiving the road image from the camera unit 110, the road condition determination unit 132 determines whether an image of an interfering object is included in the received road image in step 221.

In step 221, the road condition determination unit 132 compares the received road image with a basic pattern image stored in the memory of the navigation system 130. If an image of an object absent in the basic pattern image is found from the received road image, the image of the object is determined to be an image of an interfering object, such as an obstacle, a broken road, an uneven road, or so on. Further, the road condition determination unit 132 can determine which type of interfering object is present among the interfering objects, such as the obstacle, the broken road, the uneven road, etc., by comparing images for identifying types of interfering objects with the road image in which the image of the interfering object is present.

After a determination is made as to whether the image of the interfering object is present using the road image received from the camera unit 110 in steps 221 and 222, the road condition determination unit 132 receives acceleration variation values of the vehicle from the acceleration sensor 120.

In the navigation operation mode of the vehicle in which the voice recognition mode operates in step 201, the acceleration sensor 120 detects the speed of the vehicle in operation under control of the controller and then transmits the acceleration variation values of the vehicle extracted during an arbitrary time to the navigation system 130.

When receiving a first acceleration variation value X_{acc} and a second acceleration variation value Y_{acc} corresponding to the acceleration variation values of the vehicle from the acceleration sensor 120, the road condition determination unit 132 detects the received values in step 223. Then, the road condition determination unit 132 compares the first and second acceleration variation values X_{acc} and Y_{acc} with first and second shock threshold values Xₜₕ and Yₜₕ stored in the memory.

The first acceleration variation value X_{acc} is compared with the first shock threshold value Xₜₕ. If the first acceleration variation value X_{acc} is determined to be greater than the first shock threshold value Xₜₕ, the road condition determination unit 132 detects it in step 224. Then, the road condition determination unit 132 compares the second acceleration variation value Y_{acc} with the second shock threshold value Yₜₕ. If the second acceleration variation value Y_{acc} is determined to be greater than the second shock threshold value Yₜₕ, the road condition determination unit 132 detects it in step 225. Then, the road condition determination unit 132 determines that an interfering object is present on the road on which the vehicle travels in step 226.

In steps 221 to 226, a determination can be made as to whether an object interfering with the voice recognition is present on the road. In steps 221 and 222, the road image received from the camera unit 110 can be used for the determination. In steps 223 to 226, the acceleration variation values of the vehicle received from the acceleration sensor 120 can be used for the determination.

When an object interfering with the voice recognition is determined to be present on the road on which the vehicle travels through the process of FIG. 3, the road condition determination unit 132 notifies the controller of the presence of an interfering object. The controller detects the presence of an interfering object in step 207 of FIG. 2, stops a voice recognition process of the voice recognition unit 131, and determines whether a voice command has been input from the user.

In FIG. 2, the road condition determination unit 132 determines whether the vehicle is currently traveling on a curve road through map data stored in the memory (not illustrated) of the navigation system in step 208. The road condition determination unit 132 checks a current traveling position using the map data in step 208. The road condition determination unit 132 notifies the controller when the vehicle travels on a curve road.

If the road condition determination unit 132 notifies the controller that the vehicle is currently traveling in step 208, the controller detects it in step 209. Then, the controller stops the voice recognition process of the voice recognition unit 131 and determines whether a voice command has been received from the user.

If a voice command has been received from the user, the controller detects it in step 210. The controller outputs a voice for requesting a voice command re-input while notifying the user of a bad road condition in step 211, as shown in FIG. 4B.

If a voice command has not been received from the user, the controller detects it in step 210 and outputs a voice for notifying that an interfering object is present on the road, for example, a voice message of “This is an uneven road”, “This is an obstacle”, “This is a curve road”, etc., in step 212.

However, when information about the presence of an object interfering with the voice recognition or information about traveling on a curve road is not received from the road condition determination unit 132, the controller detects it in step 207 or 209. The controller recognizes and processes a voice command input by the user through the voice recognition unit 131 and then outputs a processing result in step 214.

A mobile terminal has been described above in the present invention. However, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

The present invention can improve voice recognition for a driver of a vehicle and can notify the driver of a current road condition by outputting a voice for notifying when a factor interfering with the voice recognition is detected on a road on which the vehicle travels.

What is claimed is:

1. An in-vehicle voice recognition apparatus operating according to a road condition, the apparatus comprising:
a camera unit for taking an image of a road on which a vehicle travels and transmitting the taken road image to a navigation system;
an acceleration sensor for measuring acceleration variation values of the vehicle during traveling and transmitting the measured acceleration variation values of the vehicle to the navigation system; and
the navigation system for controlling an operation for outputting a voice for notifying when a factor interfering with voice recognition is determined to be present on the road on which the vehicle travels through at least one of the road image received from the camera unit, the acceleration variation values of the vehicle received from the acceleration sensor, and map data.

2. The in-vehicle voice recognition apparatus of claim 1, wherein the navigation system comprises:
a road condition determination unit for determining whether a factor interfering with the voice recognition is present on the road on which the vehicle travels through the at least one of the road image received from the camera unit, the acceleration variation values of the vehicle received from the acceleration sensor, and the map data.

3. The in-vehicle voice recognition apparatus of claim 2, wherein the road condition determination unit controls an operation for outputting a voice for notifying when an object interfering with the voice recognition is determined to be present on the road on which the vehicle travels through the road image received from the camera unit.

4. The in-vehicle voice recognition apparatus of claim 2, wherein the road condition determination unit controls an operation for outputting a voice for notifying when an object interfering with the voice recognition is determined to be present on the road on which the vehicle travels through the acceleration variation values of the vehicle received from the acceleration sensor.

5. The in-vehicle voice recognition apparatus of claim 2, wherein the road condition determination unit determines whether an object interfering with the voice recognition is present on the road on which the vehicle travels through the road image received from the camera unit, determines whether an object interfering with the voice recognition is present on the road on which the vehicle travels through the acceleration variation values of the vehicle received from the acceleration sensor when the interfering object is determined to be present through the road image, and controls an operation for outputting a voice for notifying when an interfering object is determined to be present through the acceleration variation values of the vehicle.

6. The in-vehicle voice recognition apparatus of claim 2, wherein the road condition determination unit controls an operation for outputting a voice for notifying when the vehicle travels on a curve road interfering with the voice recognition through the map data.

7. The in-vehicle voice recognition apparatus of claim 1, wherein the navigation system controls an operation for outputting a voice for notifying that a factor interfering with the voice recognition is present on the road on which the vehicle travels, and an operation for outputting a voice for requesting a user to re-input a voice command according to a factor interfering with the voice recognition on the road.

8. The in-vehicle voice recognition apparatus of claim 1, wherein the navigation system comprises:
a voice recognition unit for processing voice input by a user.

9. The in-vehicle voice recognition apparatus of claim 1, wherein the acceleration sensor is installed in the navigation system.

10. An in-vehicle voice recognition method operating according to a road condition, the method comprising the steps of:
checking road conditions during traveling in navigation operation mode when a voice recognition mode operates in a vehicle; and
outputting a voice for notifying when a factor interfering with voice recognition is determined to be present on a road on which the vehicle travels.

11. The in-vehicle voice recognition method of claim 10, wherein the step of checking road conditions comprises:
receiving a road image from a camera unit while the vehicle travels; and
determining whether an object interfering with the voice recognition is present on the road on which the vehicle travels when an interfering object is searched for from the road image.

12. The in-vehicle voice recognition method of claim 10, wherein the step of checking road condition comprises:
receiving acceleration variation values (X_{acc} and Y_{acc}) of the vehicle from an acceleration sensor;
comparing a first acceleration variation value (X_{acc}) of the acceleration variation values with a first shock threshold value (Xₜₕ);
comparing a second acceleration variation value (Y_{acc}) of the acceleration variation values with a second shock threshold value (Yₜₕ) when the first acceleration variation value (X_{acc}) is greater than the first shock threshold value (Xₜₕ); and
determining that an object interfering with the voice recognition is present on the road on which the vehicle travels when the second acceleration variation value (Y_{acc}) of the acceleration variation values is greater than the second shock threshold value (Yₜₕ).

13. The in-vehicle voice recognition method of claim 10, wherein the step of checking road conditions comprises:
determining whether an object interfering with the voice recognition is present on the road on which the vehicle travels when an interfering object is searched for from a road image received from a camera unit;
receiving acceleration variation values (X_{acc} and Y_{acc}) of the vehicle from an acceleration sensor when an interfering object is determined to be present through the road image; and
determining that an object interfering with the voice recognition is present on the road on which the vehicle travels when a first acceleration variation value (X_{acc}) of the acceleration variation values is greater than a first shock threshold value (Xₜₕ) and a second acceleration variation value (Y_{acc}) of the acceleration variation values is greater than a second shock threshold value (Yₜₕ).

14. The in-vehicle voice recognition method of claim 10, wherein the step of checking road conditions comprises:
checking road conditions through map data while the vehicle travels; and
determining that the vehicle travels on a curve road interfering with the voice recognition when the vehicle travels on the curve road.

15. The in-vehicle voice recognition method of claim 10, wherein the step of outputting a voice comprises:
determining whether a voice command has been input from a user when a factor interfering with the voice recognition is determined to be present on the road on which the vehicle travels;
requesting a voice command re-input through voice while notifying that a factor interfering with the voice recognition is present on the road on which the vehicle travels when the voice command has been input; and
outputting a voice for notifying that a factor interfering with the voice recognition is present on the road on which the vehicle travels when the voice command has not been input.

16. An in-vehicle voice recognition method operating according to a road condition, the method comprising the steps of:
checking road conditions during traveling when a user inputs a voice command in a navigation operation mode of a vehicle in which a voice recognition mode operates; and
requesting a voice command re-input through voice when a factor interfering with voice recognition is determined to be present on a road on which the vehicle travels according to a result obtained by checking road conditions.

17. The in-vehicle voice recognition method of claim 16, wherein the step of checking road conditions comprises:
determining whether an object interfering with the voice recognition is present on the road on which the vehicle travels through at least one of a road image received from a camera unit and acceleration variation values of the vehicle received from an acceleration sensor; and
determining whether the vehicle travels on a curve road interfering with the voice recognition through map data.

18. The in-vehicle voice recognition method of claim 17, wherein the step of determining whether an object interfering with the voice recognition is present comprises:
receiving a road image from the camera unit while the vehicle travels; and
determining that an object interfering with the voice recognition is present on the road on which the vehicle travels when an image of the interfering object is searched for from the road image.

19. The in-vehicle voice recognition method of claim 17, wherein the step of determining whether an object interfering with the voice recognition is present comprises:
receiving acceleration variation values (X_{acc} and Y_{acc}) of the vehicle from the acceleration sensor;
comparing a first acceleration variation value (X_{acc}) of the acceleration variation values with a first shock threshold value (Xₜₕ);
comparing a second acceleration variation value (Y_{acc}) of the acceleration variation values with a second shock threshold value (Yₜₕ) when the first acceleration variation value (X_{acc}) is greater than the first shock threshold value (Xₜₕ); and
determining that the object interfering with the voice recognition is present on the road on which the vehicle travels when the second acceleration variation value (Y_{acc}) of the acceleration variation values is greater than the second shock threshold value (Yₜₕ).

20. The in-vehicle voice recognition method of claim 17, wherein the step of determining whether an object interfering with the voice recognition is present comprises:
determining whether an object interfering with the voice recognition is present on the road on which the vehicle travels when the interfering object is searched for from the road image received from the camera unit;
receiving acceleration variation values (X_{acc} and Y_{acc}) of the vehicle from the acceleration sensor when the interfering object is determined to be present through the road image; and
determining that an object interfering with the voice recognition is present on the road on which the vehicle travels when a first acceleration variation value (X_{acc}) of the acceleration variation values is greater than a first shock threshold value (Xₜₕ) and a second acceleration variation value (Y_{acc}) of the acceleration variation values is greater than a second shock threshold value (Yₜₕ).

21. The in-vehicle voice recognition method of claim 17, wherein the step of determining whether the vehicle travels on a curved road comprises:
checking road conditions through the map data while the vehicle travels; and
determining that the vehicle travels on the curved road interfering with the voice recognition when the vehicle travels on the curved road.
